(19) United States
(12) Patent Application Publication
(10) Pub. No.: US 2020/0397533 A1
(43) Pub. Date: Dec. 24, 2020

(54) DENTAL EXTRACTION DEVICE

(71) Applicant: Chao-Lin Liu, New Taipei City (TW)

(72) Inventor: Chao-Lin Liu, New Taipei City (TW)

(21) Appl. No.: 16/446,648

(22) Filed: Jun. 20, 2019

(51) Int. Cl. A61C 3/14

(52) U.S. Cl. CPC A61C 3/14; A61C 3/02

(57) ABSTRACT

A dental extraction device includes a gripping assembly including first and second gripping arm, a prying element including a driving arm and an abutting and hooking portion, two first cushioning members defined on the second gripping arm, a first spacing portion formed between the first cushioning members, and a second cushioning member defined on the second gripping arm at one side of the first spacing portion. To extract a tooth, a tooth holding member is first fixed to a tooth to be removed and then the first or second cushioning members are placed on one or more teeth that are not to be removed to serve as a support point and the abutting and hooking portion is set in engagement with the tooth holding member. The first and second gripping arms are then moved to cause the driving arm to drive the abutting and hooking portion for pulling out the tooth.

### TECHNICAL FIELD OF THE INVENTION

The present invention relates to a dental extraction device, and more particularly to a dental extraction device that has a simple structure and is easy to operate, and allows for performance of tooth extraction with a minimized wound to reduce damages to the surrounding tissues and also to reduce tools used and extraction forces applied.

### DESCRIPTION OF THE PRIOR ART

Exodontia or dental extraction is an operation of removing a tooth from a mouth cavity. Local anesthesia is often applied to the mouth cavity before dental extraction is performed. A common way of tooth extraction is forceps extraction. However, this is only applicable when there is a sufficient portion of a tooth crown left. Forceps are first used to securely grasp the crown and rocks forth and back or twists in order to break the bonding between the tooth root and alveolar bone to then remove and pull the tooth out. For teeth that are located at difficult sites, other ways of removing the teeth may be used, such as picking, pushing, and wedging, or a tooth to be removed is first split into several parts to be individually removed. For teeth that are hidden under gums or those that do not properly erupt or those that have only the roots left in the gums, surgical extraction must be applied by first opening the gums or even the bones to expose the teeth to be removed, and then a dental extraction device can be used to remove the teeth. Such a process is obviously complicated and involves a number of dental extraction instruments. Particularly, such a process often generates sounds and pains that might cause panics of patients, making tooth extraction scaring to most patients even in this modem world where the medical science has been well developed.

Chinese Patent CN1735386A discloses a method and a device for removing a tooth root. This dental instrument includes a “nail”, such as a root canal screw, fixed in the root and a tension device, such as steel cable, is activated in order to apply an electrically operated or twisting operation to extract and pull out the root in an axial direction thereof. Although this prior art document claims a large extraction force can be applied to the root with a simple operation such that there is no need for a user to apply a large effort and no issue concerning space requirement would occur, and the potential risk of causing damage to the mouth can be reduced, the cost of fabrication or the sales prices are not affordable to the users, and such a device is only applicable to removal of tooth root, making the application thereof very limited, leading to extremely low cost-performance ratio. Although, in such a known device, forces that are applied to rock and twist the tooth can be saved, forces still need to be applied to securely grasp the device itself in order to resist backward pulling of the tension device.

Such a known dental instrument, in the use thereof, suffers at least the following advantages:

(1) The fabrication cost or the sales price is high, making it adverse to popularization in the dental field.

(2) The use or application thereof is limited.

(3) A substantive amount of force must be applied to resist the tension device, making the operation of such a device not easy.

### SUMMARY OF THE INVENTION

In view of the above, the present invention aims to provide a dental extraction device that has a simple structure and is easy to operate, and allows for performance of tooth extraction with a minimized wound to reduce damages to the surrounding tissues and also to reduce tools used and extraction forces applied.

The primary objective of the present invention is simplification of operation such that a single gripping assembly fits for various applications of regular tooth extraction and removal of a residual root of a tooth.

To achieve the above objective, the present invention comprises, structurally, a gripping assembly, which comprises a first gripping arm and a second gripping arm pivoted on the first gripping arm, a prying element provided on one end of the first gripping arm and comprising a driving arm formed on the one end of the first gripping arm and an abutting and hooking portion formed on one end of the driving arm for operation in combination with a tooth holding member to extract a first tooth, two first cushioning members defined one end of the second gripping arm for abutting against a plurality of second teeth to serve as a force application support point for the prying element, a first spacing portion formed between the first cushioning members to receive the prying element in the first spacing portion in a movable manner, and a second cushioning member defined on one end of the second gripping arm and located at one side of the first spacing portion for abutting against second teeth to serve as a force application support point for the prying element.

When a user attempts to use the present invention to extract a tooth, such as a first tooth, a tooth holding member is first applied to fix to or to clamp the first tooth. Then, according to a distribution of second teeth, the first cushioning members or the second cushioning member is used and set to abut against the second teeth, and the abutting and hooking portion is set in abutting or hooking engagement with one side of the tooth holding member. Finally, the user may gradually apply a force on the gripping assembly to have the first gripping arm and the second gripping arm oscillate relative to each other so that the driving arm drives the abutting and hooking portion to move upward to thereby pull up the first tooth with the minimum tool and the least effort.

With such a technique, the shortcomings of a prior art dental extraction device having a high cost, limited application, effort-consuming operation, and poor popularization, can be overcome to thereby achieve an advantage of the above-described benefits.

### BRIEF DESCRIPTION OF THE DRAWINGS

FIG. 1 is a perspective view showing a first preferred embodiment of the present invention.

FIG. 2 is another perspective view showing the first preferred embodiment of the present invention.

FIG. 3 is a perspective view showing a tooth holding member of the first preferred embodiment of the present invention.

FIG. 4 is a schematic view illustrating mounting of the first preferred embodiment of the present invention.

FIG. 5 is a schematic view illustrating operating of the first preferred embodiment of the present invention.

FIG. 6 is a schematic view illustrating abutting of the first preferred embodiment of the present invention.

FIG. 7 is a schematic view illustrating tooth removing of the first preferred embodiment of the present invention.

FIG. 8 is another schematic view illustrating abutting of the first preferred embodiment of the present invention.

FIG. 9 is a schematic view illustrating replacing of the first preferred embodiment of the present invention.

FIG. 10 is a schematic view illustrating a structure of the first preferred embodiment of the present invention.

FIG. 11 is a perspective view showing a tooth holding member of a second preferred embodiment of the present invention.

FIG. 12 is a schematic view illustrating mounting of the second preferred embodiment of the present invention.

FIG. 13 is a schematic view illustrating tooth removing of the second preferred embodiment of the present invention.

FIG. 14 is a schematic view illustrating replacing of a third preferred embodiment of the present invention.

FIG. 15 is a schematic view illustrating abutting of the third preferred embodiment of the present invention.

FIG. 16 is a schematic view illustrating force arm extending of a fourth preferred embodiment of the present invention.

FIG. 17 is a schematic view illustrating assembling of a compressing element of a fifth preferred embodiment of the present invention.

FIG. 18 is a schematic view illustrating compressing of the fifth preferred embodiment of the present invention.

FIG. 19 is a schematic view illustrating a tooth holding member of a sixth preferred embodiment of the present invention.

FIG. 20 is a schematic view illustrating clamping of the sixth preferred embodiment of the present invention.

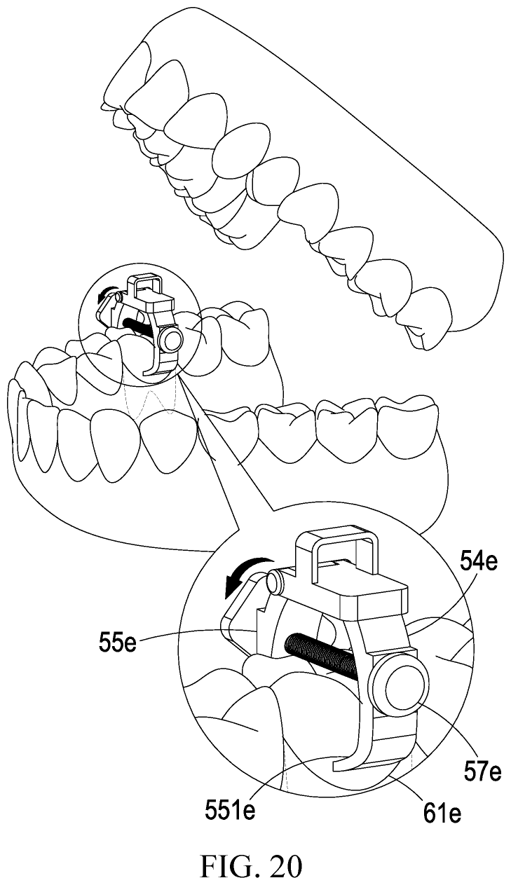

FIG. 21 is a schematic view illustrating tooth removing of the sixth preferred embodiment of the present invention.

FIG. 22 is a schematic view illustrating a tooth holding member of a seventh preferred embodiment of the present invention.

FIG. 23 is a schematic view illustrating clamping of the seventh preferred embodiment of the present invention.

FIG. 24 is a schematic view illustrating tooth removing of the seventh preferred embodiment of the present invention.

FIG. 25 is a schematic view illustrating operating of an eighth preferred embodiment of the present invention.

### DETAILED DESCRIPTION OF THE PREFERRED EMBODIMENT

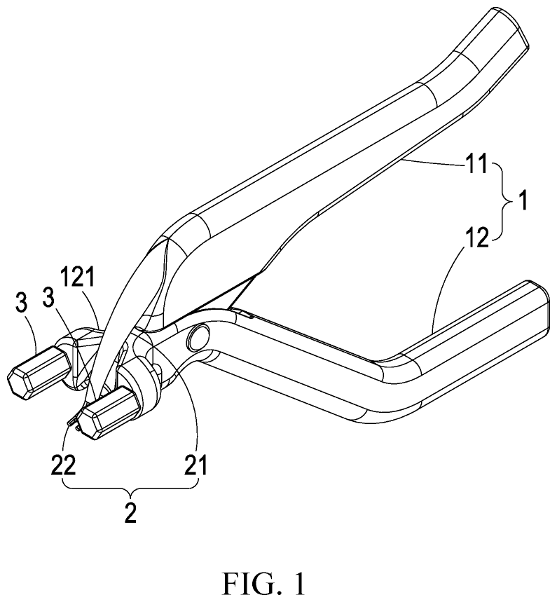

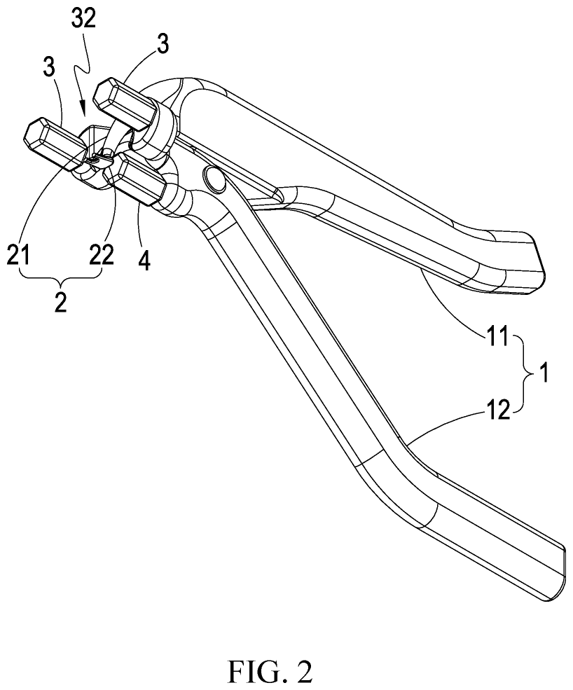

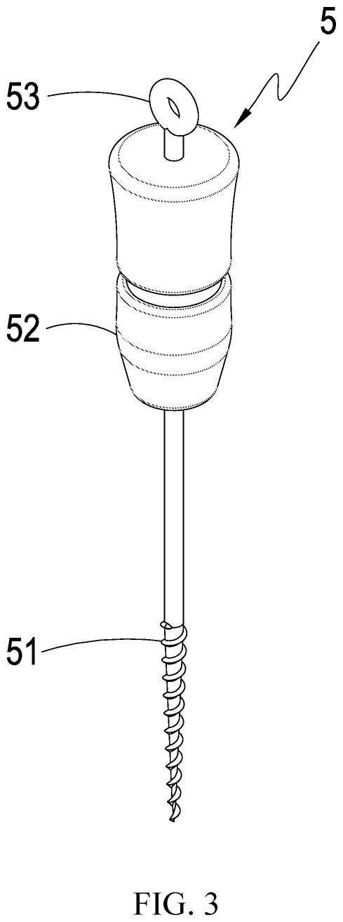

Referring to FIGS. 1-3, which are respectively a perspective view showing a first preferred embodiment of the present invention, another perspective view showing the first preferred embodiment of the present invention, and a perspective view showing a tooth holding member of the first preferred embodiment of the present invention, these drawing clearly show the present invention comprises:

a gripping assembly 1, the gripping assembly 1 comprising a first gripping arm 11 and a second gripping arm 12 pivoted on the first gripping arm 11;

a recess 121 formed on the second gripping arm 12 for receiving and accommodating a corner of a mouth;

a prying element 2 formed on one end of the first gripping arm 11, the prying element 2 comprising a driving arm 21 formed on one end of the first gripping arm 11, and an abutting and hooking portion 22 formed on one end of the driving arm 21, which is operatively cooperating with a tooth holding member 5 to extract a first tooth;

two first cushioning members 3 defined on one end of the second gripping arm 12 for abutting a plurality of second teeth to serve as a force application support point for the prying element 2;

a first spacing portion 32 formed between the first cushioning members 3, the prying element 2 being movable in the first spacing portion 3; and

a second cushioning member 4 defined on one end of the second gripping arm 12 and located at one side of the first spacing portion 32 for abutting against the second teeth to serve as a force application support point for the prying element 2.

In the device, the tooth holding member 5 comprises a tooth drilling portion 51, a gripping head 52 arranged on one end of the tooth drilling portion 51, and a positioning portion 53 formed on an end face of the gripping head 52 that is distant from the tooth drilling portion 51.

The above description provides an understanding of the structure of the present invention, and a corresponding combination based on such a structure further possesses advantages of having a simple structure and being easy to operate, and allowing for performance of tooth extraction with a minimized wound to reduce damages to the surrounding tissues and also to reduce tools used and extraction forces applied. Details are provided below.

Referring simultaneously to FIGS. 1-10, which are respectively a perspective view showing a first preferred embodiment of the present invention, another perspective view showing the first preferred embodiment of the present invention, a perspective view showing a tooth holding member of the first preferred embodiment of the present invention, a schematic view illustrating mounting of the first preferred embodiment of the present invention, a schematic view illustrating operating of the first preferred embodiment of the present invention, a schematic view illustrating abutting of the first preferred embodiment of the present invention, a schematic view illustrating tooth removing of the first preferred embodiment of the present invention, another schematic view illustrating abutting of the first preferred embodiment of the present invention, a schematic view illustrating replacing of the first preferred embodiment of the present invention, and a schematic view illustrating a structure of the first preferred embodiment of the present invention, through combining the above-described components, it can be clearly seen in the drawings the in the instant embodiment, the first gripping arm 11 and the prying element 2 are integrally formed as a unitary structure, and the second gripping arm 12, the first cushioning members 3, and the second cushioning member 4 are integrally formed as a unitary structure. This, in combination with the first gripping arm 11 and the second gripping arm 12 being pivoted to each other, the gripping assembly 1 is operable through the leverage principle to pry up the first tooth 61 (a tooth of an affected part).

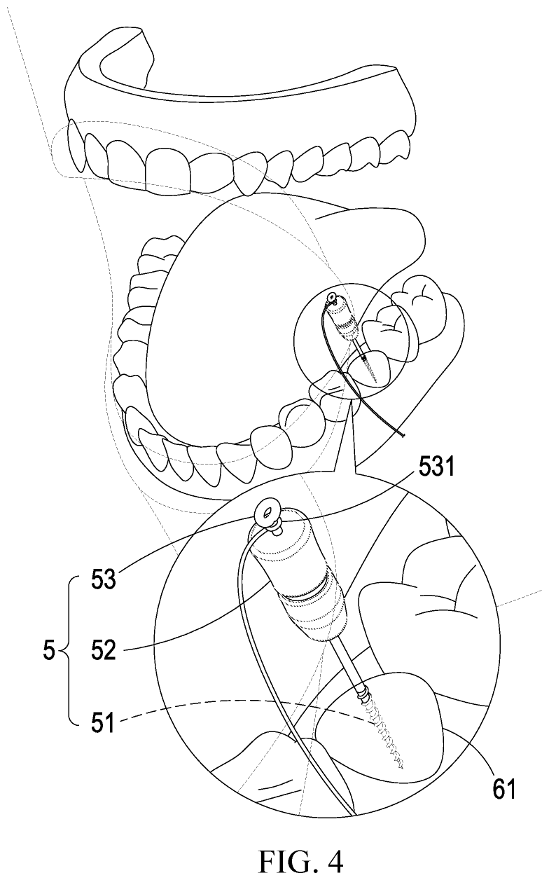

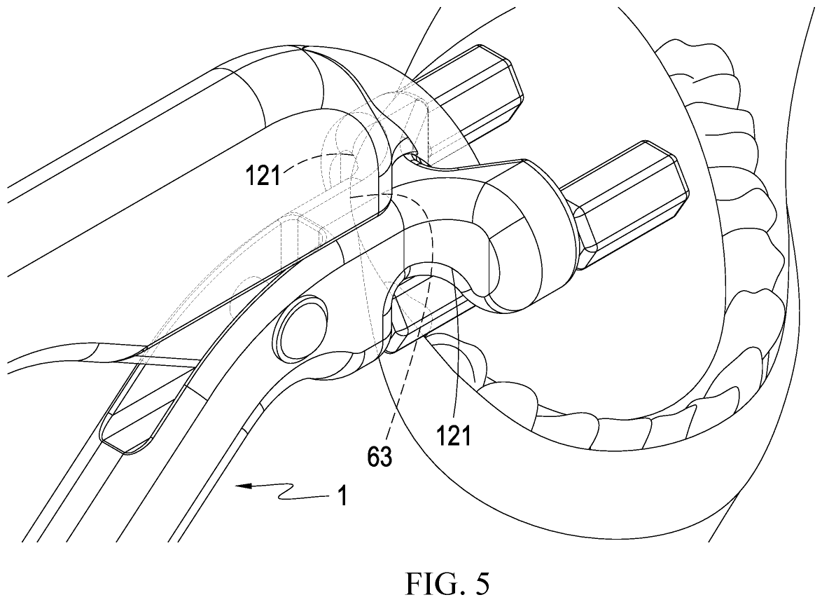

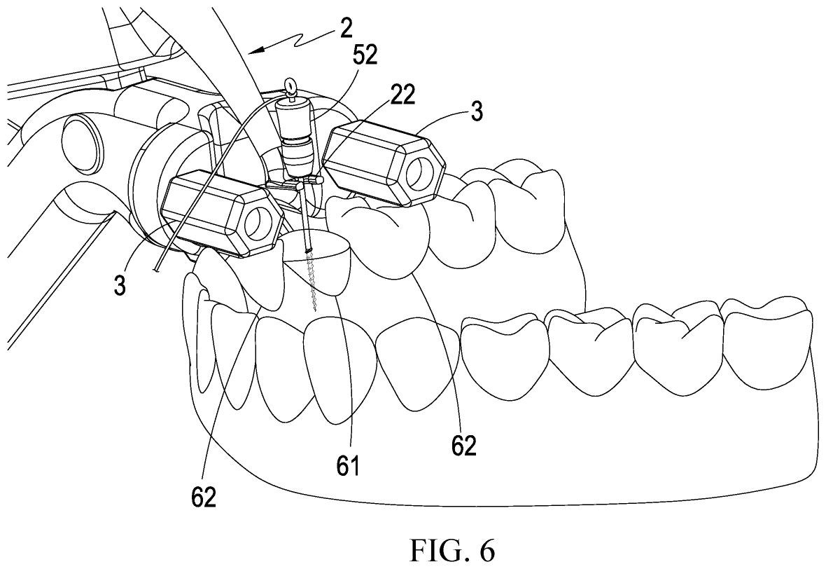

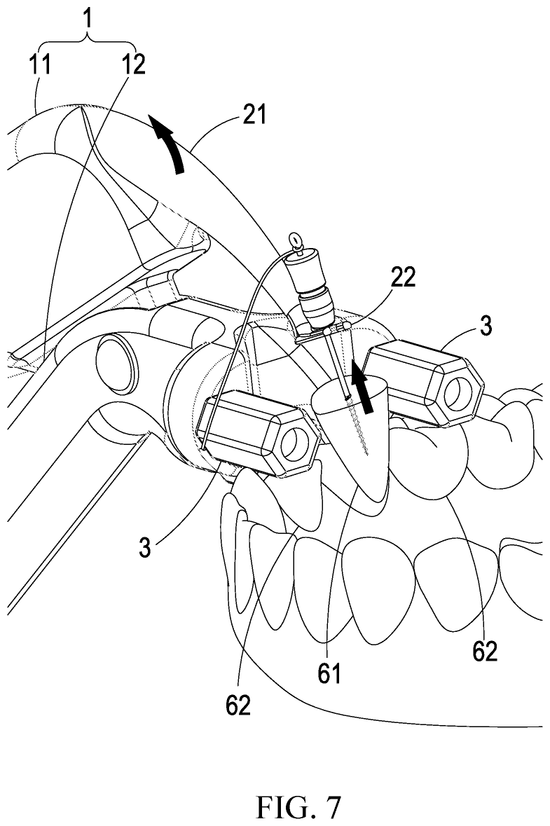

In actual use, a tooth holding member 5 is first attached to and fixed to the first tooth 61. In the instant embodiment, a residual root part of a tooth is taken as an example of the first tooth 61, and thus, the tooth holding member 5 is formed as being improvement of a root canal screw, so as to preserve an existing tooth drilling portion 51 and being uniquely formed with a gripping head 52 for being abutted against by the prying element 2, a top face of the gripping head 52 being designed with a positioning portion 53 to be held through penetrating therethrough or wrapping thereon a tooth wire or tooth floss 531 for avoiding the potential risk of the first tooth 61 flying away when being pulled out. Thus, the tooth holding member 5 is fixed to the first tooth 61 by having the tooth drilling portion 51 drilling along a never tube with the gripping head 52 exposed (as shown in FIG. 4). Then, the gripping assembly 1 is placed in to the mouth cavity of a patient, and at this moment, due to the arrangement of the recess 121, the corner of the mouth 63 can be partly accommodated in the recess 121 to reduce the extent that cheeks is expanded by the gripping assembly 1 and thus reducing the discomfort of the patient (as shown in FIG. 5). And, then, according to the distribution of the second teeth 62 (namely other teeth), the first cushioning members 3 or the second cushioning member 4m may be place to abut against the second teeth 62, as shown in FIG. 6, to allow the user to use the first cushioning members 3 that are located on two sides of the prying element 2 to abut against the second teeth 62 that are located on the two sides (left and right sides) of the first tooth 61 and the abutting and hooking portion 22 abutting against an underside of the gripping head 52, wherein the underside of the gripping head 52 is arranged in a curved or arc configuration (or being arranged in a configuration having a reduced diameter), so that in addition to assist positioning of the abutting and hooking portion 22, it is possible to prevent contact with other second teeth 62 at neighboring regions. Finally, as shown in FIG. 7, the user gradually applies a fore to the gripping assembly 1, and with the first cushioning members 3 as a force application support point, the first gripping arm 11 and the second gripping arm 12 are forced to swing relative to each other to allow the driving arm 21 to drive the abutting and hooking portion 22 to move upward whereby extraction of the first tooth 61 is achieved with the least effort by using the minimum tools. In this, a connection portion of the driving arm 21 and the first gripping arm 11 is made relatively robust and show an enhanced structural strength in order to support the application of an external force in tooth extraction. A portion of the driving arm 21 that is adjacent to the abutting and hooking portion 22 is arranged to have a size that is slightly smaller than a width of a tooth, so that the driving arm 21 is arranged in a gradually converging or reducing configuration.

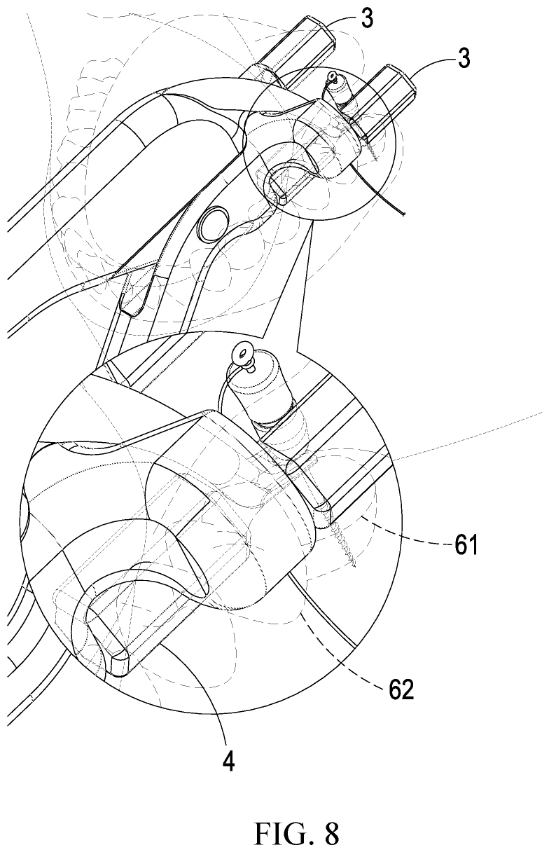

Further, as shown in FIG. 8, if the distribution of the second teeth 62 or the location of the first tooth 61 is not good for abutting engagement of the first cushioning members 3, abutting can be realized with the second cushioning member 4. For example, if the first tooth 61 is a wisdom tooth (the innermost tooth), since the second tooth 62 is present at just one side of the first tooth 61 and it is impossible to use the two first cushioning members 3 to abut against the second teeth 62 on the left and right sides simultaneously, and thus, the second cushioning member 4 is used as a substitute for abutting against a single second tooth 62, this achieving the same purpose of easing application of force.

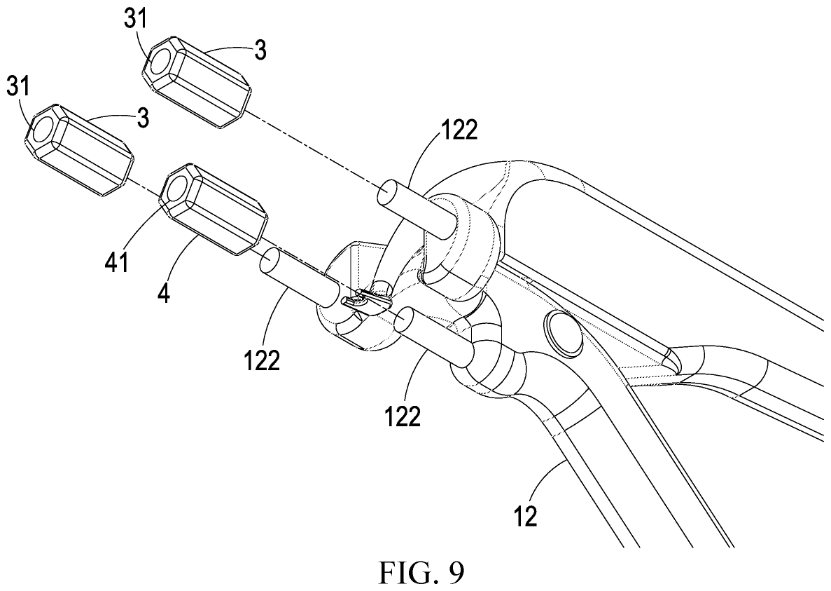

As shown in FIG. 9, for hygiene and safety purposes, the second gripping arm 12 may be provided with a plurality of first cushioning and jointing portions 122 (which are each made in the form of a rod in the instant embodiment), and each of the first cushioning members 3 and the second cushioning member 4 is provided with a second cushioning and jointing portion 31, 41 (which is made in the form of a hole in the instant embodiment) engageable and connectable with each of the first cushioning and jointing portions 122. As such, the first cushioning members 3 and the second cushioning member 4 can be removed, after each use, for substitution with new ones and disinfection can be eliminated.

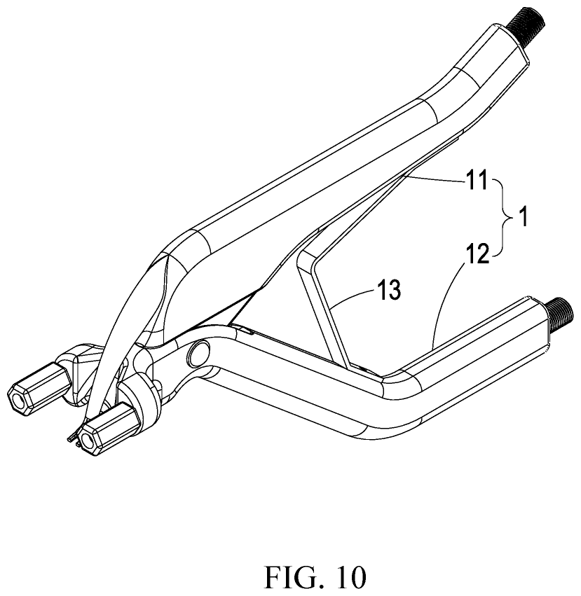

As shown in FIG. 10, in an operation of the gripping assembly 1, the first gripping arm 11 and the second gripping arm 12 collaboratively provide a gripping action that is generally increasing a compressing force or sometimes, even pulled backward partly, in order to reduce the patient's feeling of pain and avoid undesired damage to tissues and organizations other than the first tooth 61. Thus, to enhance operation convenience of the gripping assembly 1, it is preferred that the gripping assembly 1 is provided with an elastic element 13 that is connected between the first gripping arm 11 and the second gripping arm 12, so that when a user releases a compressing operation applied with the first gripping arm 11 and the second gripping arm 12, automatic returning through back springing could be achieved. In the instant embodiment, a spring plate is taken as an example for the elastic element 13.

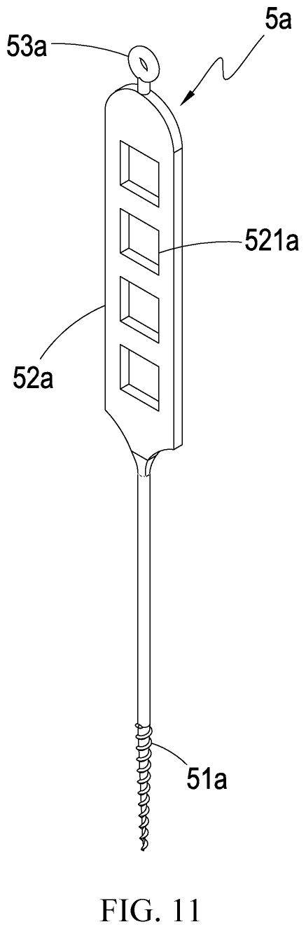

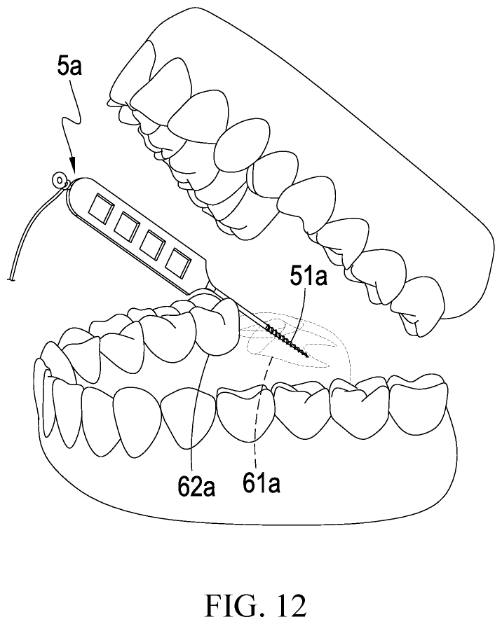

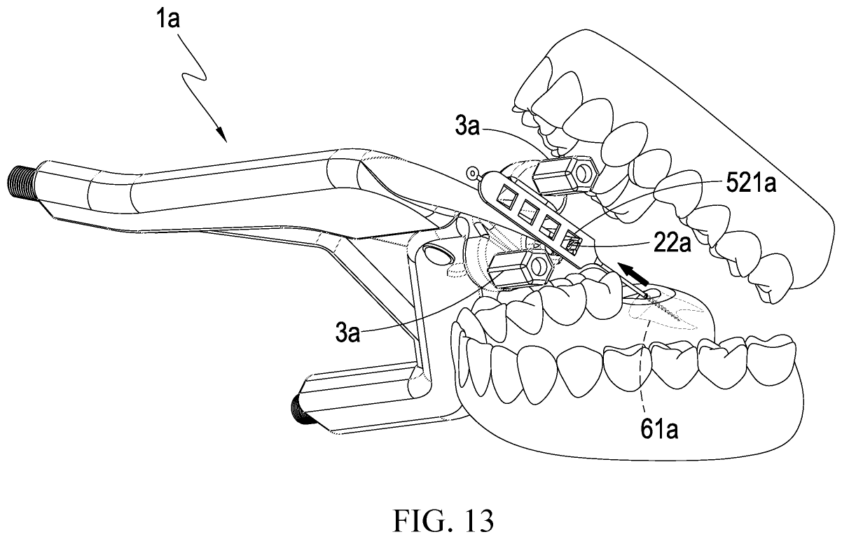

Referring to FIGS. 11-13 simultaneously, which are respectively a perspective view showing a tooth holding member of a second preferred embodiment of the present invention, a schematic view illustrating mounting of the second preferred embodiment of the present invention, and a schematic view illustrating tooth removing of the second preferred embodiment of the present invention, it can be clearly seen from the drawings that the instant embodiment is generally similar to the previous embodiment and the only difference is that a tooth holding member 5a has a gripping head 52a that comprises a plurality of engaging and hooking portions 521a that are arranged side by side, preferably in an arrayed manner, and also, the tooth holding member 5a is structured to have an outside appearance of an elongate nail as shown in FIG. 11. The tooth holding member 5a similarly comprises a tooth drilling portion 51a, a gripping head 52a, and a positioning portion 53a, and such a configuration is fit for extraction of a horizontal wisdom tooth (a first tooth 61a). In an actual use, a tooth crown portion of the first tooth 61a is first cut and removed in order to make a space between the first tooth 61a and adjacent second teeth 62a. Then, the tooth drilling portion 51a is attached to and fixed to the first tooth 61a, and then, in pulling out the tooth, the patient is guided to open the mouth to allow a dentist to place the first cushioning members 3 for abutting against the second teeth 62a on the upper and lower jars in order to enhance the effect of positioning and supporting power of the first cushioning members 3, so that similarly, with the first cushioning members 3a serving as a force application support point, the abutting and hooking portion 22an is set in one of the engaging and hooking portions 521a that is at a proper location and then, based on the principle similar to that described above, the gripping assembly 1a can be operated to pull out the first tooth 61a.

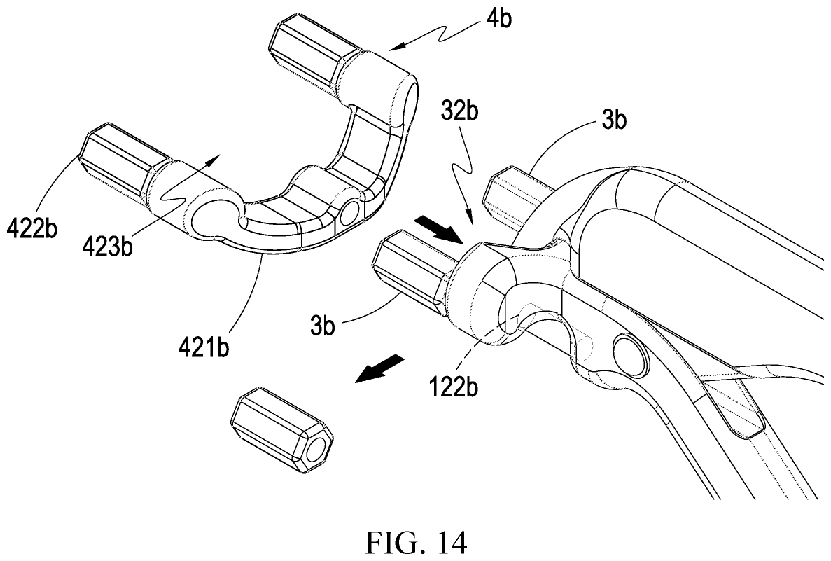

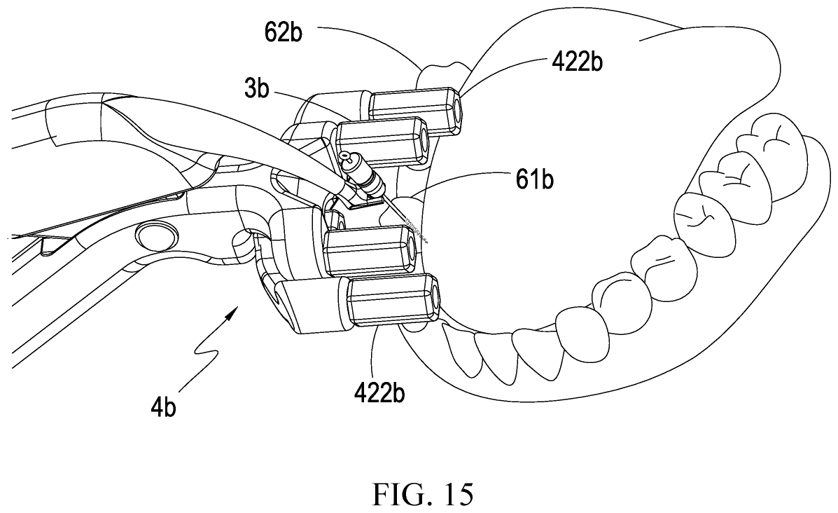

Referring to FIGS. 14 and 15 simultaneously, which are a schematic view illustrating replacing of a third preferred embodiment of the present invention and a schematic view illustrating abutting of the third preferred embodiment of the present invention, it can be clearly seen from the drawings, the instant embodiment is generally similar to the previous embodiments and the difference is that the second cushioning member 4b comprises an arm extending portion 421b and two cushioning portions 422b respectively arranged on two opposite sides of the arm extending portion 421b, and a second spacing portion 423b is arranged between the two cushioning portions 422b and has a width greater than the first spacing portion 32b. Based on the design of the first cushioning and jointing portion 122b, the second cushioning member 4b can be replaced with or changed to an outside appearance of the instant embodiment, in which the cushioning portions 422b are arranged at the opposite sides of the arm extending portion 421b, so that the spacing distance of the two cushioning portions 422b is or defines the size of the second spacing portion 423b, and the width of the second spacing portion 423b is equal to the width of the first spacing portion 32b, making the two cushioning portions 422b located on an outer side of the first cushioning members 3b, meaning in case that no or only an incomplete second tooth 62b is present at a neighboring location of the first tooth 61b, the second cushioning member 4b of the instant embodiment can be used by having the cushioning portions 422b (or simultaneously with the first cushioning members 3b) to abutting against second teeth 62b that are distant from the first tooth 61b, and as such, the applicability of the present invention to diversified situations is enhanced.

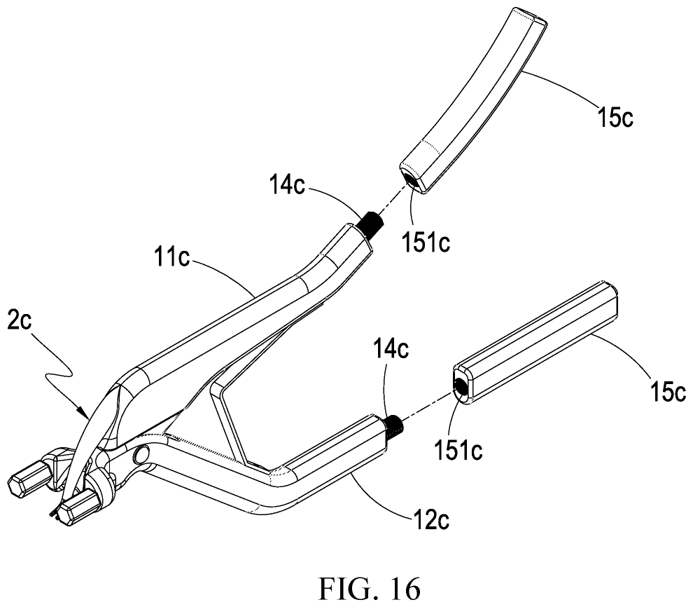

Referring to FIG. 16, is a schematic view illustrating force arm extending of a fourth preferred embodiment of the present invention, it can be clearly seen from the drawings, the instant embodiment is generally similar to the previous embodiments and the difference is that one end of each of the first gripping arm 11c and the second gripping arm 12c that is distant from the prying element 2c is provided with a first force arm jointing portion 14c, and the first force arm jointing portion 14c is provided with a force arm extending member 15c, and each of the force arm extending members 15c is provided with a second force arm jointing portion 151c that is corresponding to and connectable with a respective one of the first force arm jointing portions 14c, wherein the first force arm jointing portions 14c and the second force arm jointing portions 151c are respectively connected and fixed together through screwing engagement. As such, a user may add the force arm extending member 15c at the distal ends of the first gripping arm 11c and the second gripping arm 12c to increase the torque length for leverage thereby reducing the required force that the user applies to the first gripping arm 11c and the second gripping arm 12c, achieving an effect of effort saving.

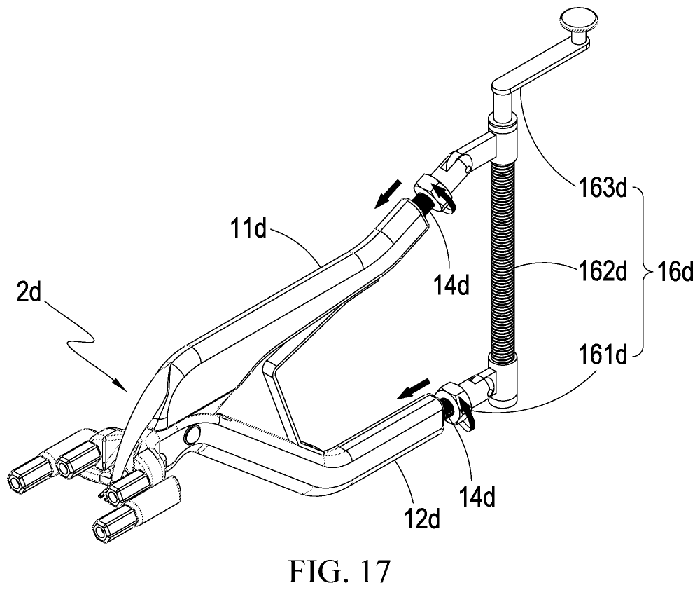

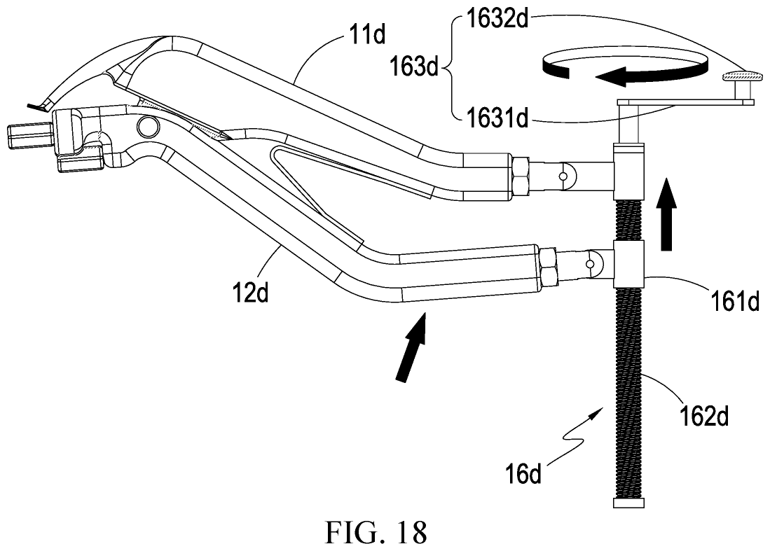

Referring to FIGS. 17 and 18 simultaneously, which are respectively a schematic view illustrating assembling of a compressing element of a fifth preferred embodiment of the present invention and a schematic view illustrating compressing of the fifth preferred embodiment of the present invention, it can be clearly seen from the drawings that the instant embodiment is generally similar to the previous embodiments and the difference is that one end of each of the first gripping arm 11d and the second gripping arm 12d that is distant from the prying element 2d is provided with a first force arm jointing portion 14d, and the first force arm jointing portion 14d is provided with a compressing element 16d, and the compressing element 16d is provided with a plurality of third force arm jointing portions 161d that are respectively corresponding to and combinable with the first force arm jointing portions 14d. The compressing element 16d comprises a screw rod portion 162d and an operating portion 163d for rotating the screw rod portion 162d. The third force arm jointing portions 161d are mounted, in a rotatable manner, on the screw rod portion 162d, wherein the first force arm jointing portions 14d and the third force arm jointing portions 161d are respectively jointed and fixed together through screwing engagement, so that rotating the operating portion 163d drives the screw rod portion 162d to rotate and further, the operating portion 163d of the instant embodiment is made up of a connection bar 1631d and a roller 1632d rotatably mounted on the connection bar 1631d, making it convenient for a user to grip, with finger tips, the roller 1632d to control the turning of the connection bar 1631d. At this moment, due to the third force arm jointing portions 161d being fixedly arranged on the distal, rear ends of the first gripping arm 11d and the second gripping arm 12d, the rotation of the screw rod portion 162d causes the third force arm jointing portions 161d to contract inwardly (wherein, in the instant embodiment, the third force arm jointing portion 161d at the distal, rear end of the first gripping arm 11d is kept fixed, while the third force arm jointing portion 161d at the distal rear end of the second gripping arm 12d is forced to move upward), as such, an operation similar to a jack is adopted and the compressing element 16d takes the place of manual application of force for the operation thereby further reducing the requirement of operation forces that the user has be apply.

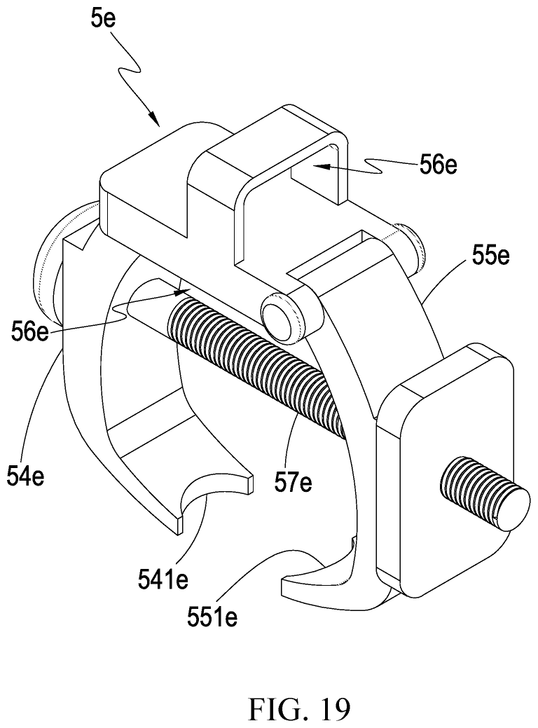

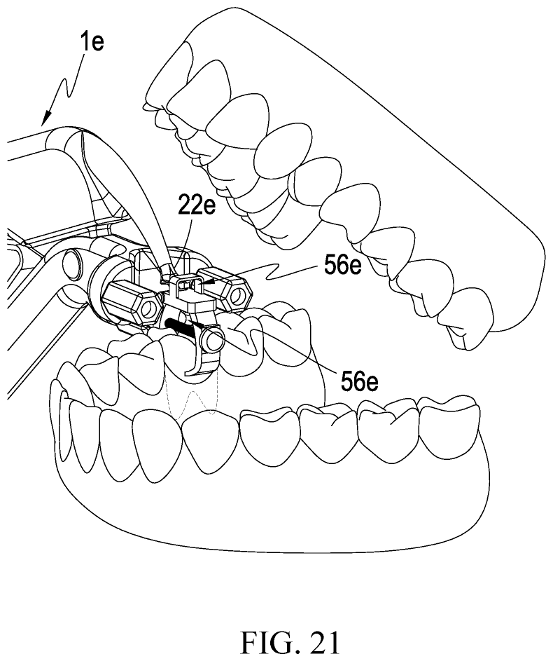

Referring to FIGS. 19 and 21 simultaneously, which are respectively a schematic view illustrating a tooth holding member of a sixth preferred embodiment of the present invention and a schematic view illustrating clamping of the sixth preferred embodiment of the present invention, it can be clearly seen from the drawings that the instant embodiment is generally similar to the previous embodiments and the difference is that this embodiment provides a different configuration of the tooth holding member 5e. The tooth holding member 5e comprises a first clamping arm 54e, a second clamping arm 55e pivoted to the first clamping arm 54e, a first clamping portion 541e formed on one end of the first clamping arm 54e, a second clamping portion 551e formed on one end of the second clamping arm 55e, at least one through hole portion 56e formed on one side of the first clamping arm 54e and the second clamping arm 55e and operable in combination with the abutting and hooking portion 22e, and a tightening member 57e arranged on the first clamping arm 54e and the second clamping arm 55e, such that the above structure makes a tooth holding member 5e that adopts a clamping operation to fix at sides of a tooth crown of the first tooth 61e, meaning in addition to use for removing a residual root of a tooth, the present invention is also applicable to remove a regular tooth.

In an actual use, the first clamping arm 54e and the second clamping arm 55e are respectively positioned at two sides of the first tooth 61e and a tightening degree of the tightening member 57e is properly adjusted so that through the design as a screw rod, the second clamping arm 55e that is pivoted to one side of the first clamping arm 54e could be caused to contract inward, making the first clamping portion 541e and the second clamping portion 551e jointly embrace the side surface of the first tooth 61e. And, in the instant embodiment, the first clamping portion 541e and the second clamping portion 551e are structured to show a circular arc configuration, allowing for positioning, in a floating manner, against the side surface of the first tooth 61e. After a tightening operation is completed, the abutting and hooking portion 22e can be set through the through hole portion 56e and the gripping assembly 1e be operated to pull up the first tooth 61e. In this, the through hole portion 56e can be of a hole formed and delimited by a rectangular frame as shown in the drawings, can alternatively be a hollow space located between the tightening member 57e, the first clamping arm 54e, and the second clamping arm 55e, and the opening directions of the rectangular frame and the hollow space are generally perpendicular to each other to allow the user to make abutting operations from different directions and thus enhancing operation convenience.

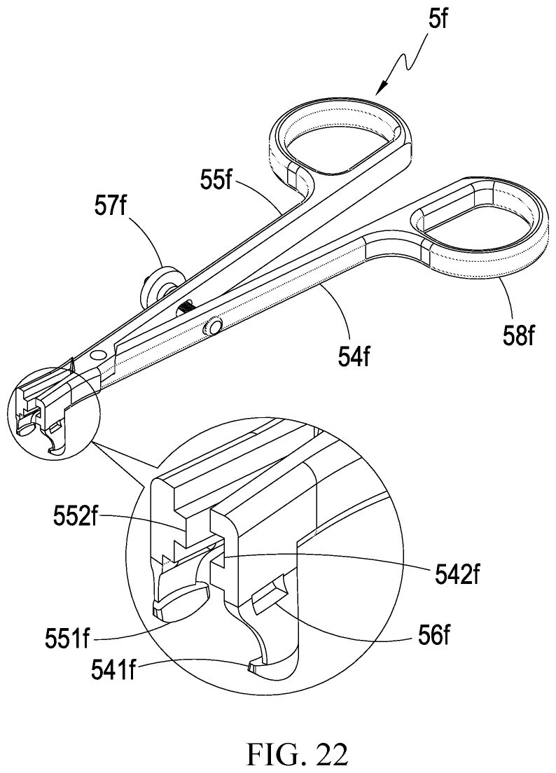

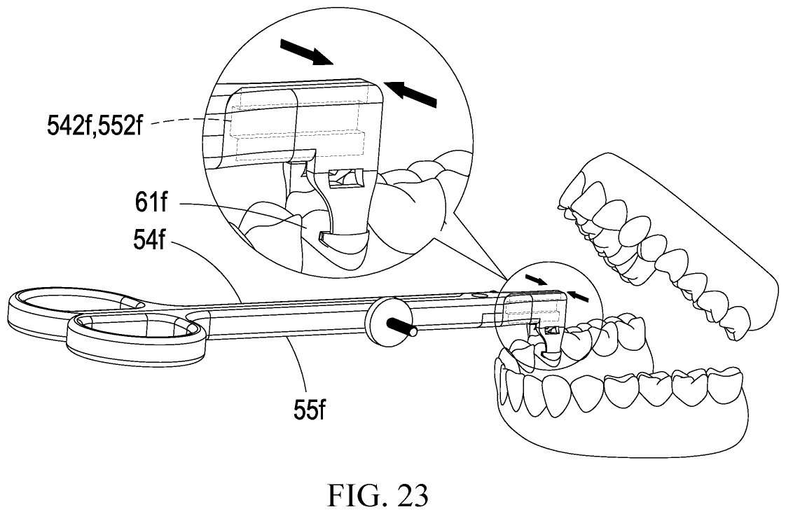

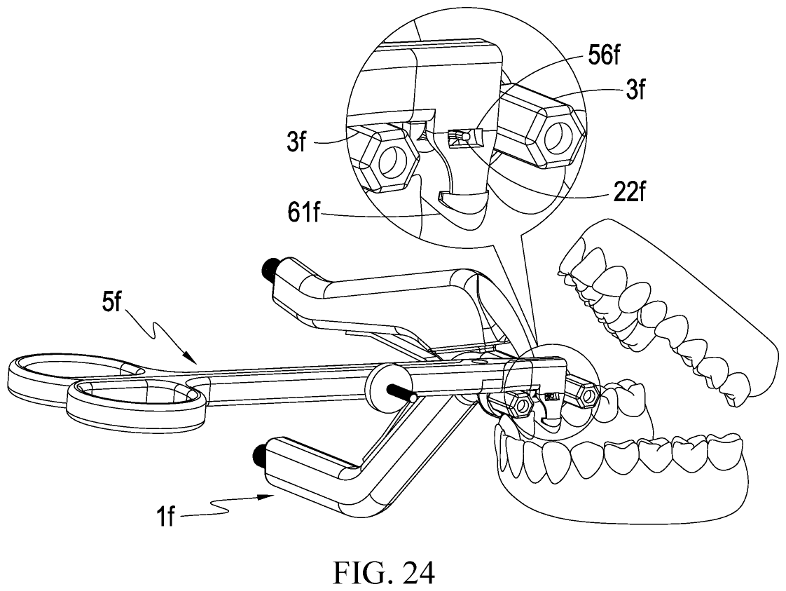

Referring to FIGS. 22-24 simultaneously, which are respectively a schematic view illustrating a tooth holding member of a seventh preferred embodiment of the present invention, a schematic view illustrating clamping of the seventh preferred embodiment of the present invention, and a schematic view illustrating tooth removing of the seventh preferred embodiment of the present invention, it can be clearly seen from the drawings, the instant embodiment is generally similar to the previous embodiment and the difference is that this embodiment provides a different configuration of the tooth holding member 5f. The tooth holding member 5f comprises a grip portion 58f arranged at one side of each of the first clamping arm 54f and the second clamping arm 55f that is distant from the first clamping portion 541f and the second clamping portion 551f. The first clamping arm 54f is provided with a first limiting portion 542f and the second clamping arm 55f is provided with a second limiting portion 552f that is corresponding to and engageable with and thus combinable with the first limiting portion 542f to collaboratively prevent the first clamping arm 54f and the second clamping arm 55f from shifting upward/downward. In the instant embodiment, the tooth holding member 5f adopts similarly an operation of clamping to fix on sides of a crown portion of the first tooth 61f; however, due to the tooth holding member 5f being structured to show a configuration of a pair of scissors, it is possible to drive the first clamping arm 54f and the second clamping arm 55f to move through operating the grip portions 58f. In order to avoid undesired upward/downward shifting caused by an excessive length of the first clamping arm 54f and the second clamping arm 55f, the first clamping arm 54f and the second clamping arm 55f are respectively provided, on inner sides thereof, with the first limiting portion 542f and the second limiting portion 552f, which are respectively made in the form of a raised block and a recessed groove so that mating through engagement between raised block and recessed groove can be achieved when the first clamping arm 54f and the second clamping arm 55f approach each other thereby providing an effect of preventing upward/downward shifting, and could, in a similar way, be fixed together by using a tightening member 57f after clamping is done. As such, the gripping assembly if can be used in combination with the scissors-like tooth holding member 5f such that the first cushioning members 3f serve as a supporting portion and a force can be applied through the through hole portion 56f of the abutting and hooking portion 22f to allow the user to position the first clamping portion 541f and the second clamping portion 551f to embrace an outside surface of the first tooth 61f.

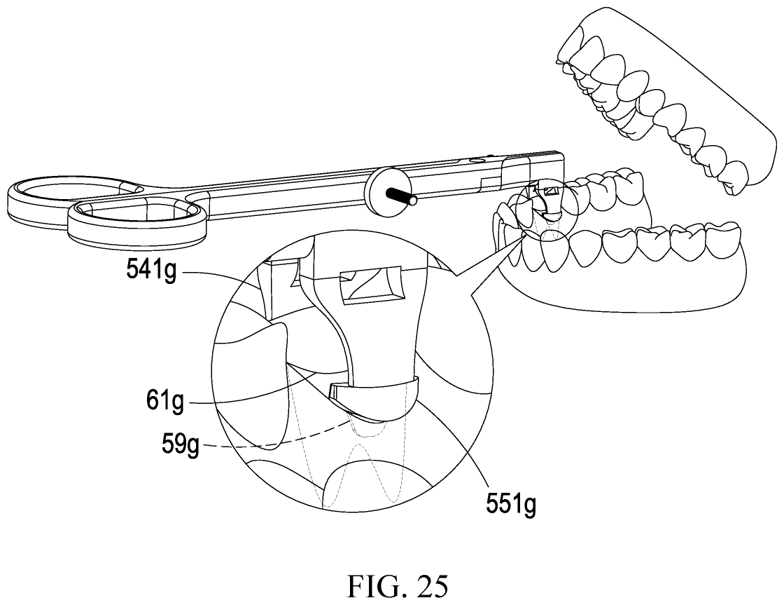

Referring to FIG. 25, which is a schematic view illustrating operating of an eighth preferred embodiment of the present invention, it can be clearly seen from the drawings, the instant embodiment is generally similar to the previous embodiments and the difference is that the first clamping portion 541g and the second clamping portion 551g are each provided, on one side thereof, with an extended clamping portion 59g. As such, even in a case that the first tooth 61g is just a redial root part of a tooth, which does not allow the first clamping portion 541g and the second clamping portion 551g to be positioned to embrace a side surface of a crow portion, the extended clamping portions 59g can be inserted into the gums to contact the residual root portion to similarly fix the first tooth 61 through clamping. However, in this way, the magnitude of a force applied may be limited and this is only applicable to a first tooth 61g that is a root of one single tooth or roots of two teeth.

I claim:

1. A dental extraction device, comprising:
a gripping assembly, the gripping assembly comprising a first gripping arm and a second gripping arm pivoted to the first gripping arm;
a prying element formed on one end of the first gripping arm, the prying element comprising a driving arm formed on one end of the first gripping arm and an abutting and hooking portion formed on one end of the driving arm and operable in combination with a tooth holding member to extract a first tooth;
two first cushioning members defined on one end of the second gripping arm and are operable for abutting against a plurality of second teeth to serve as a force application support point for the prying element;
a first spacing portion formed between the first cushioning members, the prying element being movable in the first spacing portion; and
a second cushioning member defined on one end of the second gripping arm and located in the first spacing portion one side of and operable for abutting against the second teeth to serve as a force application support point for the prying element.

2. The dental extraction device according to claim 1, wherein the second gripping arm comprises a plurality of first cushioning and jointing portions, and each of the first cushioning members and the second cushioning member is provided with a second cushioning and jointing portion engageable with and connectable to a respective one of the first cushioning and jointing portions.

3. The dental extraction device according to claim 2, wherein the second cushioning member comprises an arm extending portion and two cushioning portions respectively arranged on two opposite sides of the arm extending portion, and a second spacing portion is arranged between the two cushioning portions and has a width greater than the first spacing portion.

4. The dental extraction device according to claim 1, wherein the gripping assembly comprises an elastic element connected between the first gripping arm and the second gripping arm.

5. The dental extraction device according to claim 1, wherein the first gripping arm and the second gripping arm are each provided, on one end thereof distant from the prying element, with a first force arm jointing portion, the first force arm jointing portions being each provided with a force arm extending member, each of the force arm extending members being provided with a second force arm jointing portion that is corresponding to and connectable with a respective one of the first force arm jointing portions.

6. The dental extraction device according to claim 1, wherein the first gripping arm and the second gripping arm are each provided, on one end thereof distant from the prying element one end of, with a first force arm jointing portion, a compressing element being mounted to the first force arm jointing portions, the compressing element comprising a plurality of third force arm jointing portions that are respectively corresponding to and combinable with the first force arm jointing portions.

7. The dental extraction device according to claim 6, wherein the compressing element comprises a screw rod portion and an operating portion for rotating the screw rod portion, the third force arm jointing portions being mounted, in a rotatable manner, on the screw rod portion.

8. The dental extraction device according to claim 1, wherein the tooth holding member comprises a first clamping arm, a second clamping arm pivoted to the first clamping arm, a first clamping portion formed on one end of the first clamping arm, a second clamping portion formed on one end of the second clamping arm, at least one through hole portion formed on one side of the first clamping arm and the second clamping arm and operable in combination with the abutting and hooking portion, and a tightening member arranged on the first clamping arm and the second clamping arm.

9. The dental extraction device according to claim 8, wherein the tooth holding member comprises a grip portion arranged at one side of each of the first clamping arm and the second clamping arm that is distant from the first clamping portion and the second clamping portion.

10. The dental extraction device according to claim 8, wherein the first clamping arm is provided with a first limiting portion and the second clamping arm is provided with a second limiting portion that is corresponding to and engageable with and thus combinable with the first limiting portion to prevent the first clamping arm and the second clamping arm from shifting upward/downward.

11. The dental extraction device according to claim 8, wherein the first clamping portion and the second clamping portion are each provided, on one side thereof, with an extended clamping portion.
